(19) United States
(12) Patent Application Publication
(10) Pub. No.: US 2017/0241841 A1
(43) Pub. Date: Aug. 24, 2017

(54) MEASUREMENT PROBE COMPRISING A SENSITIVE ELEMENT

(71) Applicant: SC2N, Creteil (FR)

(72) Inventors: Olivier Gueguen, Caen (FR); Arnaud Bouteveilles, Blainville Sur Orne (FR); Philippe Couasse, Benouville (FR)

(73) Assignee: SC2N, Creteil (FR)

(21) Appl. No.: 15/512,254

(22) PCT Filed: Sep. 15, 2015
(86) PCT No.: PCT/FR2015/052462

§ 371 Date: Mar. 17, 2017

(30) Foreign Application Priority Data
Sep. 19, 2014 (FR) 1458877

(51) Int. Cl. G01K 1/14; G01L 19/00

(52) U.S. Cl. CPC G01K 1/14; G01L 19/0092; G01K 2205/00

(57) ABSTRACT

The invention relates to a measurement probe comprising a sensitive element and two legs connected to the sensitive element, said legs being coplanar.

The present invention relates to a measurement probe, notably used in the automotive sector.

Probes are known for measuring a temperature; for example, a probe provided with a temperature-sensitive element positioned in a fluid flow, in an intake air flow of a combustion engine of a vehicle. This placement in the flow advantageously allows accurate temperature information to be obtained. This, however, involves placing the sensitive element relatively far from the rest of the probe, notably a printed circuit board or ceramic support which is not placed in the fluid flow. This connection, between the sensitive element and the printed circuit board or the ceramic support, is made by legs of sufficient length, notably between 10 and 50 mm.

During the assembly of the probe, these relatively long connecting legs are shaped by bending operations prior to the assembly with the printed circuit board, with correct positioning.

The probe is configured in a three-dimensional configuration before the assembly operations in the sensor begin.

The probe therefore has a mounting direction, making automatic assembly by a robot delicate as automatic recognition of the orientation of probe becomes necessary.

The diameter of the legs is notably between 0.2 millimeter and 0.6 millimeter, rendering the mechanical strength of the three-dimensional structure formed by the measuring probe quite low.

As a result, handling of the probe during the assembly operations may alter the geometric configuration which was provided, such that the ends of the wires no longer coincide, or only partially coincide, with the connector pads of the printed circuit board or the ceramic support. Due to this imperfect positioning, the quality of the electrical connection between the legs and the printed circuit board is degraded or faulty, notably generating production rejects or even electrical faults.

The object of the present invention is notably to overcome one or more drawbacks of the devices of the prior art.

To do this, the present invention proposes a measurement probe, including:
a sensitive element,
two legs connected to the sensitive element, these legs being coplanar.

The fact that the legs of the measurement probe are coplanar allows it to be handled without creating stress that would tend to distort the legs.

According to an embodiment of the invention, the legs each have an electrical connection portion, these connection portions being arranged collinearly.

According to a characteristic of the invention, these connection portions are arranged to point in opposite directions.

According to another characteristic of the invention, the connection portions of the legs are symmetrical to one another with respect to a median plane passing through the sensitive element.

There is no mounting direction as the measurement probe is symmetric. The risk of an installation error is thus removed.

According to yet another characteristic of the invention, each of the connecting legs have a rectilinear portion connecting to the associated connection portion.

Advantageously, the rectilinear portions are parallel to each other.

Preferably, the rectilinear portions are longer than the length of the connection portions.

According to an embodiment of the invention, the rectilinear portion and the connection portion of each leg form an angle substantially equal to 90° between them.

For example, the developed length of one of the legs is between 10 and 80 millimeters, notably between 20 and 60 millimeters.

Preferably, the connection portion is stripped and the rectilinear portion is at least partially covered by an insulating sheath or a coating.

Where appropriate, the connection portion has a diameter less than 1 millimeter, notably between 0.2 millimeter and 0.6 millimeter, preferably between 0.25 millimeter and 0.45 millimeter.

According to an embodiment of the invention, the sensitive element is sensitive to the temperature of its environment.

For example, the sensitive element comprises a negative temperature coefficient thermistor.

Alternatively, the sensitive element comprises a positive temperature coefficient thermistor.

Further alternatively, the sensitive element comprises a thermocouple.

According to an embodiment of the invention, the probe is arranged to be electrically connected, notably by brazing, to a substrate, particularly a printed circuit board or a ceramic support.

The invention also relates to a sensor, notably for motor vehicles, including:
a substrate, notably a printed circuit board or a ceramic support,
a measurement probe as described above, electrically connected, notably by brazing, to the substrate.

According to an embodiment of the invention, the substrate has at least one opening and the measurement probe is arranged at least partially in said opening.

Where appropriate, the sensor has a support carrying the substrate and this support is provided with at least one guide element arranged to cooperate with the connection portion of the leg of the probe.

Preferably, the guide element has a cavity capable of at least partially receiving the connection portion of the measurement probe, this cavity notably having a V or U shape.

Advantageously, the guide element of the measurement probe is arranged to guide the substrate during its installation in the support.

In an embodiment of the invention, the temperature sensor includes:
a measurement probe as described above, arranged to measure a temperature,
a pressure measurement probe, notably separated from the temperature measurement probe, the two probes being in contact with the same fluid,
a connector for connecting the sensor to an electric or electronic system, adapted to read the measurement signal of each of the probes.

According to a first variant of the invention, the output signals delivered are of analog type.

According to a second variant of the invention, the output signals delivered are of digital type.

The invention also relates to an intake air manifold for an internal combustion engine incorporating a sensor as described above.

The invention further relates to an internal combustion engine incorporating a manifold as described above.

Finally, the invention also relates to a method of assembling the probe in a sensor as described above.

The invention shall be better understood upon reading the following description, accompanied by the annexed drawings given by way of example.

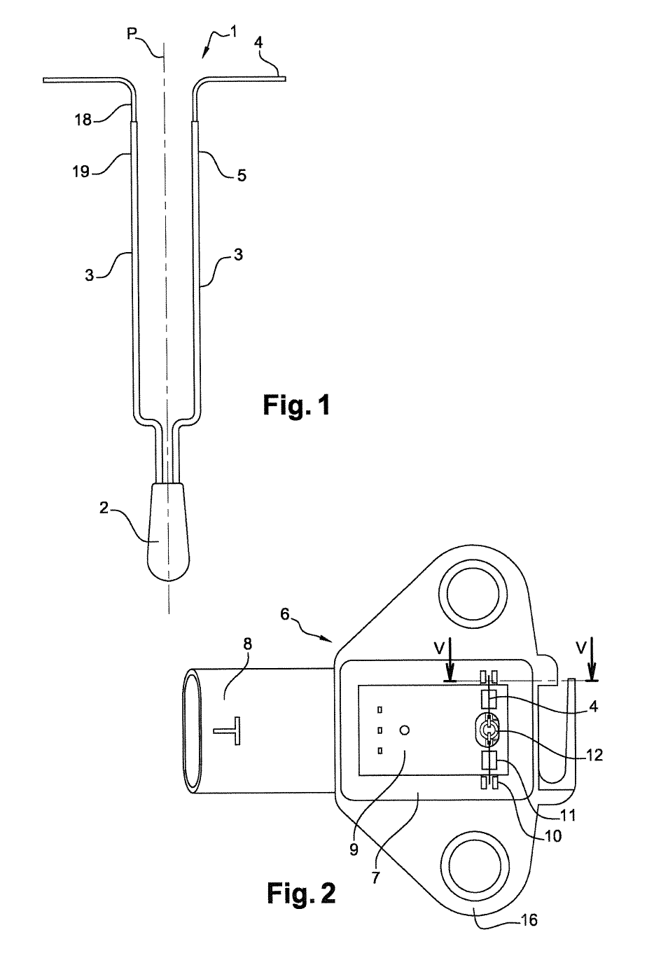

FIG. 1 represents, schematically and partially, a measurement probe in accordance with an exemplary implementation of the invention described.

FIG. 2 is a partial view of a sensor comprising the probe of FIG. 1.

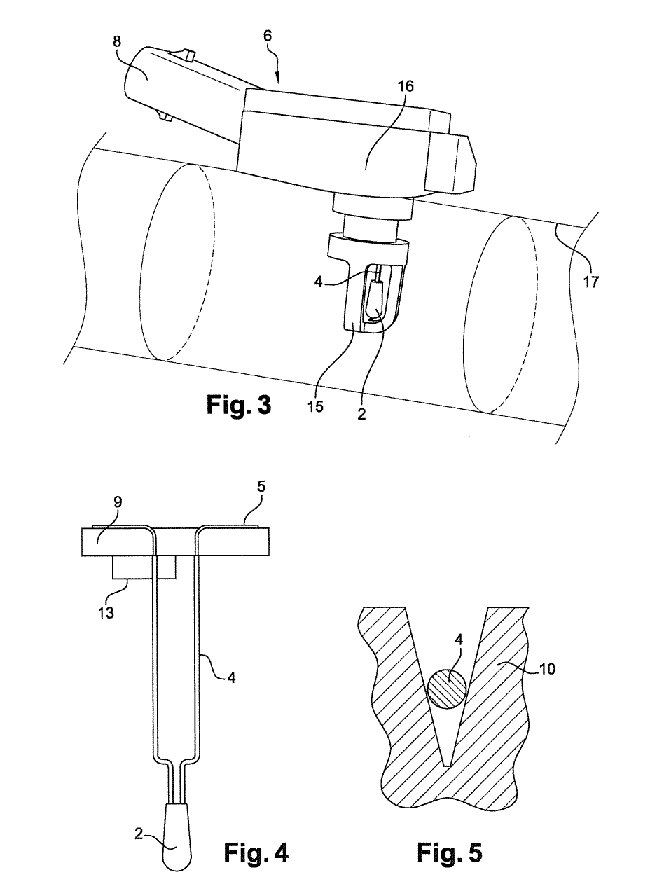

FIG. 3 is a perspective view of the sensor of FIG. 2.

FIG. 4 shows, using a schematic and partial view of the sensor, an example of integration of a measurement probe according to the invention in a sensor.

FIG. 5 represents a cross-sectional view of a guide element of the sensor of FIGS. 2 and 3.

The present invention relates to a measurement probe, intended to be integrated in a sensor.

An embodiment relates to a pressure and temperature sensor, notably measuring the pressure and the inlet temperature of a combustion engine, and incorporating a measurement probe according to the invention.

FIG. 1 shows a probe 1 according to an exemplary implementation of the invention, this probe 1 including:
a sensitive element 2,
two coplanar legs 3 connected to the sensitive element.

Each end of the legs 3 has a connection portion 4. These electric connection portions 4 are arranged in a collinear manner or possibly forming a small angle between them, between 0° and 5°, resulting from possible geometrical defects during manufacturing.

According to an embodiment of the invention, the legs 3 each have a connection portion 4, these connection portions 4 being arranged to point in opposite directions.

As also illustrated in FIG. 1, the connection portions 4 of the legs 3 are symmetrical to one another with respect to a median plane P passing through the sensitive element 2.

The connecting legs 3 each have a rectilinear portion 5 connecting to the associated connection portion 4.

The rectilinear portions 5 are parallel.

Preferably, the rectilinear portions 5 are longer than the length of the connection portions 4.

According to an embodiment of the invention, the rectilinear portion 5 and the connection portion 4 of each leg 3 form an angle substantially equal to 90° between them.

Depending on the applications, the length varies so that the sensitive element is placed substantially at the center of the flow.

For example, the developed length of one of the legs 3 is between 10 and 80 millimeters.

Preferably, the connection portion 4 is stripped and the rectilinear portion 5 is at least partially covered by an insulating sheath or a coating. The sheath 19 covers the metallic portion 18 of the leg over a portion of its length and protects the covered portion of the legs 3 from external aggressions, chemical or mechanical, caused by the intake air.

Where appropriate, the connection portion 4 has a diameter less than 1 millimeter, notably between 0.2 millimeter and 0.6 millimeter, preferably between 0.25 millimeter and 0.45 millimeter.

According to an embodiment of the invention, the sensitive element 2 is sensitive to the temperature of its environment.

For example, the sensitive element 2 comprises a negative temperature coefficient thermistor. The electrical resistance of such an element decreases monotonically and continues when the temperature rises, according to a relationship specific to the material used to form the element.

According to another embodiment, not shown, the sensitive element 2 comprises a positive temperature coefficient thermistor. In this case, the resistance of the sensitive element increases monotonically and continuously when the temperature rises, according to a relationship specific to the material used to constitute the element.

According to another embodiment, not shown in the present application, the sensitive element 2 measuring the temperature comprises a thermocouple. This type of sensitive element creates a potential difference proportional to the temperature difference between the hot junction and the cold junction of the thermocouple.

The probe 1 is arranged to be electrically connected, notably by brazing, to a substrate 9, notably a printed circuit board or a ceramic support. As can be seen in FIG. 3, the connection portion ends 4 lie flat on the connector pads 11 of the substrate 9, for brazing to make the electrical contact.

A sensor 6 is shown in FIGS. 2 and 3, including:
a substrate 9,
the measurement probe 1, electrically connected, notably by brazing, to the substrate 9.

In FIG. 2, the protective cover, normally closing the body 7, has been removed to show the inside of the sensor 6.

The substrate 9 has an opening 12 and the measurement probe 1 is arranged at least partially in this opening. In FIG. 2, the measurement probe 1 is arranged to pass through the substrate 9.

The support 7 comprises at least one guide element 10 arranged to cooperate with the connection portion 5 of a leg 3 of the probe 1.

Preferably, the guide element 10 has a cavity capable of at least partially receiving the connection portion of the probe, this cavity notably having a V or U shape.

In FIG. 5, the cavity has a V-shape, the connection portion is inserted into the wider portion of the V and is guided laterally to abut in the bottom of the cavity.

The guide element 10 of the measurement probe 1 is also arranged to guide the substrate 9 during its installation in the support.

The installation operation of the substrate 9 is thereby facilitated.

In an embodiment of the invention, the temperature sensor, notably for a motor vehicle, includes:
a measurement probe 1 as described above, measuring a temperature,
a pressure measurement probe 13, notably separated from the temperature measurement probe 1, the 2 probes being in contact with the same fluid,
a connector 8,
the connector enabling the sensor to be connected to an electric or electronic system, adapted to read the measurement signal of each of the probes.

Such a sensor combines two functions,which limits the number of mechanical interfaces to be provided for housing these sensors in their environment, and simplifies the electrical wiring by limiting the number of connections and ramifications.

FIG. 3 represents such a sensor, where the end of the measurement probe 2 can be seen which is protected by an arch 15 arranged in the body of the sensor. This arch protects the end of the measurement probe from shocks that may occur during the transport of the component prior to assembly on the engine, during assembly on the engine or possibly during operation of the engine. The arch features wide openwork and does not prevent the air flow from reaching the measurement probe.

The output signals delivered are of analog type. In this embodiment, the member using this information acquires voltage levels delivered by the sensor.

In other applications, the output signals delivered are of digital type. In this case, the measurements between the sensor and the member using this information are transmitted via a digital communication protocol.

The invention also relates to an intake air manifold for an internal combustion engine, not shown, incorporating a sensor as described above.

The sensor described above measures the temperature and the pressure of the gas mixture flowing in the intake manifold, said mixture consisting essentially of air but possibly also containing exhaust gases recirculated to the intake, oil vapor from the recycling of crankcase gases, and fuel vapors possibly coming from the tank.

To obtain a temperature representative of the actual temperature of the fluid flow, the measurement probe will be arranged substantially in the center of the fluid stream and, in any case, far from the wall. Conversely, the pressure measurement probe may be housed inside the body of the sensor.

A portion of the inlet manifold makes a base in which the sensor is inserted, a retaining system then allowing the sensor to be held in position.

The sensor can thus be screwed, by one or more screws passing through one or more fixing brackets arranged in the body of the sensor.

The invention further relates to an internal combustion engine incorporating a manifold as described above.

The measurement of the pressure and the temperature will allow the control system controlling the internal combustion engine to notably determine the density of intake air, this information being used to optimize the control of the engine, notably to reduce polluting emissions and maximize performance.

Finally, the invention also relates to a method of assembling the measurement probe in a sensor as described above.

For the reasons mentioned above, the assembly of the sensor is facilitated in relation to the prior art when the invention is implemented.

1. A measurement probe, comprising:
a sensitive element,
two legs connected to the sensitive element, the two legs being coplanar.

2. The probe as claimed in claim 1, wherein the two legs each have an electrical connection portion, the connection portions being arranged in a collinear manner.

3. The probe as claimed in claim 2, wherein the connection portions are arranged to point in opposite directions.

4. The probe as claimed in claim 3, wherein the connection portions of the two legs are symmetrical to one another in relation to a median plane passing through the sensitive element.

5. The probe as claimed in claim 2, wherein the diameter of the connection portion is between 0.25 millimeter and 0.45 millimeter.

6. The probe as claimed in claim 1, wherein the sensitive element is sensitive to a temperature of an environment of the sensitive element.

7. A sensor for a motor vehicle, comprising:
a substrate; and
a measurement probe as claimed in claim 1, wherein the measurement probe is electrically connected by brazing to the substrate.

8. The sensor as claimed in claim 7, wherein the substrate comprises at least one opening and the measurement probe is arranged at least partially in said opening.

9. The sensor as claimed in claim 7, further comprising a support bearing the substrate and provided with at least a guide element arranged to cooperate with the connection portion of one of the two legs of the probe.

10. The sensor as claimed in claim 9, in which the guide element has a cavity capable of at least partially receiving the connection portion of the measurement probe, wherein the cavity has a V or U shape.

11. The sensor as claimed in claim 9, wherein the guide element of the measurement probe is arranged to guide the substrate when the substrate is placed in the support.

12. A temperature sensor for a motor vehicle, comprising:
a measurement probe as claimed in claim 1;
a pressure measurement probe separated from the temperature measurement probe, the two probes being in contact with the same fluid; and
a connector,
wherein the connector allows the sensor to be connected to an electric or electronic system configured to read the measurement signal of each of the probes.

13. The sensor of claim 7, wherein the substrate is one selected from a group consisting of: a printed circuit board and a ceramic support.
